(19) United States
(12) Patent Application Publication
(10) Pub. No.: US 2011/0136047 A1
(43) Pub. Date: Jun. 9, 2011

(54) FUEL CELL CATALYST SUPPORT WITH BORON CARBIDE-COATED METAL OXIDES/PHOSPHATES AND METHOD OF MANUFACTURING SAME

(76) Inventors: Belabbes Merzougui, Manchester, CT (US); Minhua Shao, Manchester, CT (US); Lesia V. Protsailo, Bolton, CT (US)

(21) Appl. No.: 13/057,308

(22) PCT Filed: Sep. 19, 2008
(86) PCT No.: PCT/US08/76948

§ 371 Date: Feb. 3, 2011

(51) Int. Cl. H01M 4/92; H01M 4/64; B05D 5/12

(52) U.S. Cl. 429/524; 429/532; 429/527; 429/525; 429/526; 427/115

(57) ABSTRACT

A fuel cell catalyst support includes a support structure having a metal oxide and/or a metal phosphate coated with a layer of boron carbide. Example metal oxides include titanium oxide, zirconium oxide, tungsten oxide, tantalum oxide, niobium oxide and oxides of yttrium, molybdenum, indium, and tin and their phosphates. A boron carbide layer is arranged on the support structure by a chemical or mechanical process, for example. Finally, a catalyst layer is deposited on the boron carbide layer.

### TECHNICAL FIELD

This disclosure relates to fuel cell catalyst supports and methods of manufacturing the same.

### BACKGROUND

Cost and durability issues have made it difficult to commercialize fuel cells. Fuel cells utilize a catalyst that creates a chemical reaction between a fuel, such as hydrogen, and an oxidant, such as oxygen, typically from air. The catalyst is typically platinum loaded onto a support, which is usually a high surface area carbon.

Some durability issues are attributable to the degradation of the support caused by corrosion. Electrochemical studies have indicated that the corrosion depends strongly on surface area and morphology structure of carbon. For example, it has been reported that carbon with high surface area, such as Ketjen Black, can corrode severely at potentials experienced during start and stop cycling of the fuel cell causing a dramatic loss in fuel cell performance. Accordingly, to overcome this particular durability issue, it may be desirable to use a support other than carbon that is more chemically and electrochemically stable.

One possible alternative support for a catalyst is a metal oxide. Metal oxides can have a high surface area and good corrosion resistance, which are desirable for fuel cell applications. However, most of these high surface area metal oxides are not conductive and are extremely hydrophilic. Hydrophilic supports can cause problems, such as electrode flooding, which leads to significant drop in cell performance, especially at high current densities. As result, existing metal oxides supports cannot be applied in low temperature fuel cells.

What is therefore needed is a modified metal oxide that is more suitable for use in a fuel cell environment.

### SUMMARY

A fuel cell catalyst support is disclosed that includes a support structure having a metal oxide/phosphate, modified with a boron carbide layer, using a chemical or mechanical process, for example. The metal catalyst layer (active layer) is supported on top of the boron carbide layer.

These and other features of the disclosure can be best understood from the following specification and drawings, the following of which is a brief description.

### BRIEF DESCRIPTION OF THE DRAWINGS

FIG. 1 is a highly schematic view of an example fuel cell.

FIG. 2 is a highly schematic view of an example metal oxide/phosphate catalyst support for the fuel cell shown in FIG. 1.

FIG. 3 illustrates an example chemical process used to form a boron carbide layer on a metal oxide/phosphate support structure.

### DETAILED DESCRIPTION

An example fuel cell 10 is schematically illustrated in FIG. 1. The fuel cell 10 includes a cell 12 having an anode 14 and a cathode 18 arranged about a proton exchange membrane 16. The anode 12 receives a fuel, such as hydrogen, from a fuel source 24. A pump 28 supplies an oxidant, such as air, from an oxidant source 26 to the cathode 18. In the example, the oxidant source 26 is a surrounding environment. The fuel and oxidant react in a controlled chemical process to produce electricity. The cell 12 and other cells 20 are arranged in a cell stack assembly 22, to provide enough electricity to power a load. The fuel cell 10 shown in FIG. 1 is exemplary only and should not be interpreted as limiting the claims.

The anode 14 and cathode 18 typically include a catalyst arranged on a catalyst support. The catalyst support provides the support structure upon which a thin layer of catalyst is deposited. Typically, the catalyst is platinum and the catalyst support is carbon, such as ketjen black, carbon fibers or graphite.

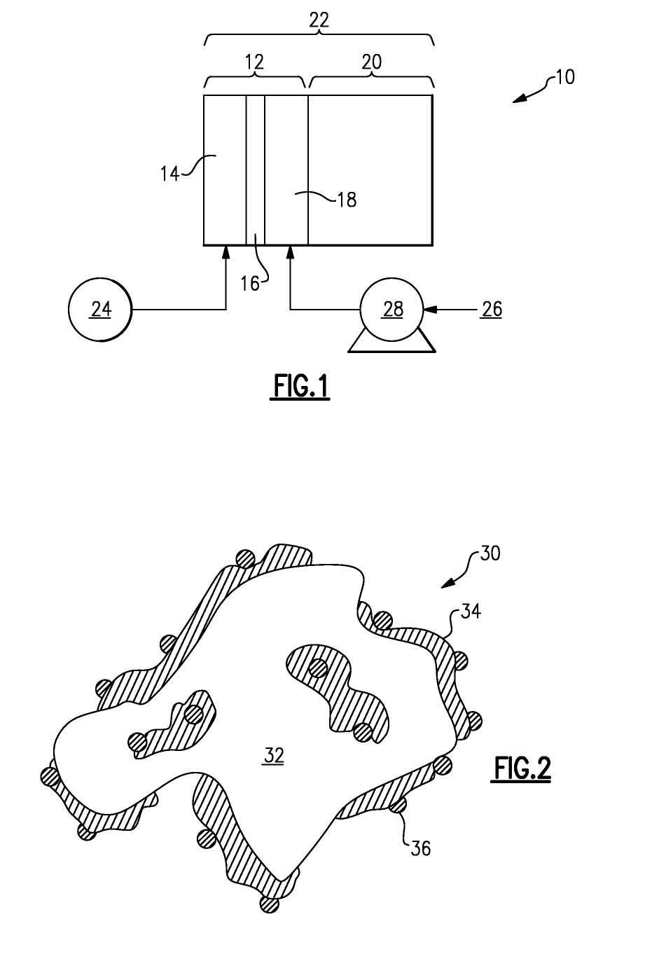

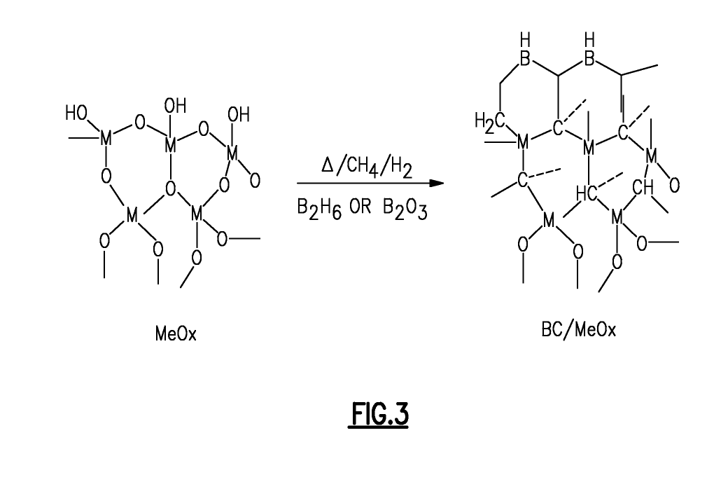

This disclosure relates to a catalyst support 30 having a metal oxide and/or metal phosphate support structure 32, as shown in FIG. 2. Example metal oxides include oxides of titanium (e.g. TiO₂ and Ti₄O₇), oxides of zirconium (ZrO₂), oxides of tungsten (WO₃), oxides of tantalum (Ta₂O₅), and oxides of niobium (NbO₂, Nb₂O₅). Other example metal oxides include oxides of yttrium, molybdenum, indium and/or tin (e.g., ITO). Example metal phosphates include TaPOx, TiPOx, and FePOx. Metal oxides/phosphates, with a high surface area, are desirable so that the active catalyst layer can be correspondingly increased. Moreover, metal oxides/phosphates are highly corrosion resistant.

Metal oxides/phosphates are typically hydrophilic, which limit their use in certain applications due to electrode flooding, particularly in the low temperature fuel cells. In addition, most of these materials are electrically isolating. Catalyst supports typically must be somewhat conductive to ensure electrons at the catalyst layer pass through the support without experiencing an undesirable amount of resistance. Thus, a catalyst support must not only more hydrophobic, but also conductive to be suitable in fuel cells. To this end, a boron carbide (B₄C) layer 34 is provided as an intermediate layer between the metal oxide/phosphate support structure 32 and the catalyst layer 36, schematically depicted in FIG. 2. Boron carbide ensures conductivity and desired hydrophilicity of the catalyst support.

While the catalyst support 30 is schematically shown as discrete, uniform layers, it should be understood that the catalyst support 30 comprises boron carbide 34 arranged between the metal oxide/phosphate support structure 32 and the catalyst layer 36. Boron carbide 34 can fully or partially cover the metal oxide/phosphate surface. Example catalysts include noble metals, such as platinum, palladium, gold, ruthenium, rhodium, iridium, osmium, or alloys thereof. A secondary metal can also be used to reduce the amount of noble metal used. Example secondary metals include transition metals, such as cobalt, nickel, iron, copper, manganese, vanadium, titanium, zirconium and chromium.

The boron carbide layer 34 forms a conductive and corrosion resistant shell on the support structure 32. In one example in which titanium oxide with a high surface area is used as the support structure 32, a high surface area layer of boron carbide can be achieved correspondingly. Boron carbide provides improved hydrophobicity to the catalyst support 30.

The boron carbide layer 34 can be chemically or mechanically deposited onto the support structure 32. An example, chemical process of forming a boron carbide layer on the metal oxide/phosphate support structure is depicted in FIG. 3. The metal oxides/phosphates can be modified in the presence of a source of boron (e.g. B₂O₃) and a mixture of methane and hydrogen (CH₄/H₂) with an optimized ratio. During the process, boron oxide reacts to form BC, which deposits on the support structure. This process uses an elevated temperature. Therefore, the top layer of metal oxide/phosphate particles may contain a mixture of metal carbide and oxide/phosphate before the boron carbide layer are deposited onto the support structure.

The boron carbide layer 34 can also be deposited mechanically on an outer surface of the support structure 32 by blasting the support structure 32 with carbon particles and a source of boron, for example, by a ball milling process.

Although an example embodiment has been disclosed, a worker of ordinary skill in this art would recognize that certain modifications would come within the scope of the claims. For that reason, the following claims should be studied to determine their true scope and content.

1. A fuel cell catalyst support comprising:
a support structure including at least one of a metal oxide and a metal phosphate;
a boron carbide arranged on the support structure to provide a top layer; and
a catalyst layer arranged on the top layer of boron carbide.

2. The fuel cell catalyst support according to claim 1, wherein the support structure includes oxides of at least one of titanium, zirconium, tungsten, tantalum, niobium, yttrium, molybdenum, indium, and tin.

3. The fuel cell catalyst support according to claim 1, wherein the support structure includes phosphates of at least one of yttrium, molybdenum, indium, tin, iron, titanium, and tantalum.

4. The fuel cell catalyst support according to claim 1, wherein the top layer is deposited on the support structure.

5. The fuel cell catalyst support according to claim 1, wherein the catalyst layer is a metal catalyst.

6. The fuel cell catalyst support according to claim 5, wherein the catalyst layer includes at least one noble metal.

7. The fuel cell catalyst support according to claim 6, wherein the noble metal includes at least one of platinum, palladium, gold, ruthenium, rhodium, iridium, osmium, or alloys thereof.

8. The fuel cell catalyst support according to claim 6, wherein the catalyst layer includes at least one transition metal.

9. The fuel cell catalyst support according to claim 8, wherein the transition metal includes at least one of cobalt, nickel, iron, copper, manganese, vanadium, titanium, zirconium and chromium.

10. A method of manufacturing a fuel cell catalyst support comprising the steps of:
providing a support structure including at least one of a metal oxide and a metal phosphate; coating the support structure with a boron carbide layer; and depositing a catalyst layer on the boron carbide layer.

11. The method according to claim 10, wherein the coating step includes reacting boric acid in mixture of methane and hydrogen and with the presence of the support structure.

12. The method according to claim 10, wherein the coating step includes blasting an outer surface of the support structure with boron and carbon sources respectively including boron particles and carbon particles.

13. The method according to claim 10, wherein the support structure includes oxides of at least one of titanium, zirconium, tungsten, tantalum, niobium, yttrium, molybdenum, indium and tin.

14. The method according to claim 10, wherein the support structure includes phosphates of at least one of yttrium, molybdenum, indium, tin, iron, titanium, and tantalum.

15. The method according to claim 10, wherein the catalyst layer includes at least one noble metal.

16. The method according to claim 15, wherein the noble metal includes at least one of platinum, palladium, gold, ruthenium, rhodium, iridium, osmium, or alloys thereof.

17. The method according to claim 15, wherein the catalyst layer includes at least one transition metal.

18. The method according to claim 17, wherein the transition metal includes at least one of cobalt, nickel, iron, copper, manganese, vanadium, titanium, zirconium and chromium.
